(19) United States
(12) Patent Application Publication
(10) Pub. No.: US 2005/0043982 A1
(43) Pub. Date: Feb. 24, 2005

(54) Contextual workflow modeling

(76) Inventor: Vinh Dinh Nguyen, Burke, VA (US)

Correspondence Address: Vinh Nguyen, Suite 500, 8300 Boone Boulevard, Vienna, VA, 22182, US

(21) Appl. No.: 10/901,159

(22) Filed: Jul. 29, 2004

Related U.S. Application Data
(60) Provisional application No. 60/496,781, filed on Aug. 22, 2003.

(51) Int. Cl. G06F 17/60

(52) U.S. Cl. 705/8

(57) ABSTRACT

A workflow modeling technique is proposed wherein a workflow is modeled as a modified finite-state machine executing strictly in the context of a data environment. The data environment isolates the state machine such that the only way to effect a change in the running status of the state machine is through modifications to the data environment. Each state in the state machine has a well-defined lifecycle. The progression of each state through its lifecycle and the transitions to other states are governed by user-defined business rules which operate on data drawn from the data environment. Business rules can also be defined to determine the executability of a particular task. Injection of data into the data environment can be accomplished either by programmatically setting values for user-defined variables or by users filling out forms interactively. User access to forms and individual data fields on a form is determined dynamically from the user's role and the current workflow status. Form layouts are handled automatically to accommodate for the visibility of individual data fields at any particular time. The task list for each user is extracted dynamically from the form access information and the current workflow data contents.

### CROSS REFERENCE TO RELATED APPLICATIONS

This application claims the benefit of prior filed provisional application No. 60/496,781, filed Aug. 22, 2003, and is incorporated herein by reference.

### BACKGROUND

Workflows are commonly modeled as activity diagrams, i.e., sequences of actions to be performed to achieve some business objective. This approach to workflow modeling is called Activity-Based Workflow Modeling (AWM). An activity diagram comprises of discrete actions and the flow from one action into one or more other actions. The transition from one action to the next is automatic and predicate on the completion of the previous action. When there are multiple transitions coming out of an action, a split occurs, resulting in the concurrent execution of multiple branches that can join up later at synchronization points. Alternatively, decision points can be used to select one among many alternate branches.

Actions in an activity diagram are grouped into swimlanes to denote the responsibilities for these actions. Each swimlane is associated with a particular role in the workflow and typically shown as a vertical or horizontal track. All actions shown in a swimlane are to be performed by the role associated with the swimlane.

While activity diagrams are a common and useful modeling technique, AWM has a number of drawbacks that limit its effectiveness in modeling complex, highly nuanced workflows. One fundamental characteristic of activity diagrams is that all actions are treated equal despite real differences in their nature. For example, some actions are user-initiated while others may be system-generated notifications or triggers. Yet other actions may be business rule executions, often referred to in the AWM literature as automatic actions. A direct consequence of this semantic flattening is that activity diagrams often become complicated very quickly from all the different types of actions being displayed indiscriminately in a diagram. It is not uncommon to see activity diagrams requiring hundreds of actions to model even moderately complex workflows. Attempting to understand these activity diagrams is often a daunting task.

The following two case studies illustrate some specific limitations of AWM.

Case Study 1—Action Interchangeability

FIG. 1 shows a workflow fragment where a document is to be signed off by both the Chief Engineer and the Program Manager, but in no particular order. The split following the Submit for Approval action 101 causes two separate branches to execute concurrently. The synchronization point 104 prior to the Store in Repository action 105 forces a wait for the completion of both Sign Off actions 102, 103 before proceeding.

Let's now add some nuance to this workflow fragment. Suppose that either the Chief Engineer or the Program Manager, but not both, needs to sign off on the document. In other words, the Chief Engineer role and the Program Manager role are interchangeable for this workflow fragment. Suppose further that the swimlanes for the two roles have to remain separate because these roles need to perform role-specific actions in other parts of the workflow. How should the activity diagram in FIG. 1 be modified to capture this nuance?

It turns out that this cannot be done in AWM without distortion of the model. One can attempt to remove the synchronization point so that the completion of one Sign Off action 102 will trigger the Store in Repository action 105. However, the remaining Sign Off action 103 still appears on the to-do list of the other role, hence becoming orphaned, unless custom code is written to remove this action explicitly. Custom code usually translates to high maintenance costs and compatibility problems during software version upgrades. In general, AWM does not handle action interchangeability gracefully.

Case Study 2—Mid-Action Transitions

Consider a workflow fragment where a contract document is reviewed. If the Contract Officer encounters a non-routine legal clause, he immediately requests assistance from the Legal Department and then continues with his review of the remainder of the document.

FIG. 2 shows an attempt at modeling this workflow fragment. While the diagram is a reasonable approximation, it doesn't quite capture the fact that the check for non-routine clauses occurs inline, as the Contract Officer reviews the document 202, and not in a separate screening step 201.

FIG. 3 shows another attempt at modeling the workflow fragment. At first glance, this model appears to work. However, if one were to examine the action history, one would see multiple instances of the Review Document action 301 that are caused by the loop-back between 302 and 301. What needs to be captured instead is a single Review Document action instance that continues after a request is made for assistance from the Legal Department.

AWM cannot capture this nuance due to the fundamental requirement in the methodology that an action be completed before a transition can occur. This case study is simply beyond the expressive power of AWM.

### BRIEF DESCRIPTION OF THE DRAWINGS

FIG. 1 shows an example activity diagram modeling a document sign-off process involving a Chief Engineer and a Program Manager.

FIG. 2 shows the first attempt at modeling the second case study using an activity diagram.

FIG. 3 shows the second attempt at modeling the second case study using an activity diagram.

FIG. 4 shows an example of the hierarchical structure of data fields on a form.

FIG. 5 shows the CWM diagram for modeling the first case study.

FIG. 6 shows the CWM diagram for modeling the second case study.

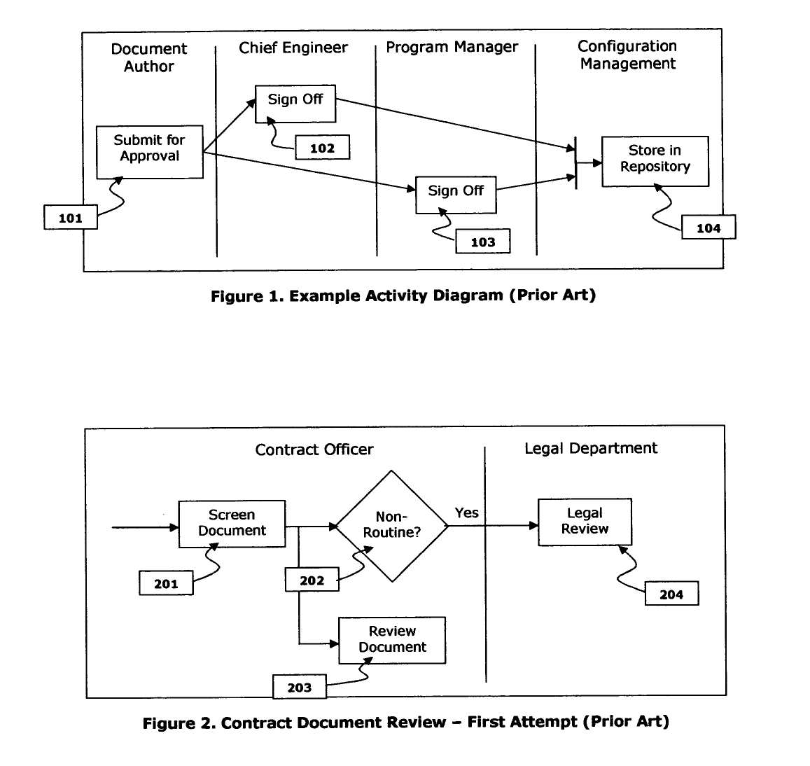

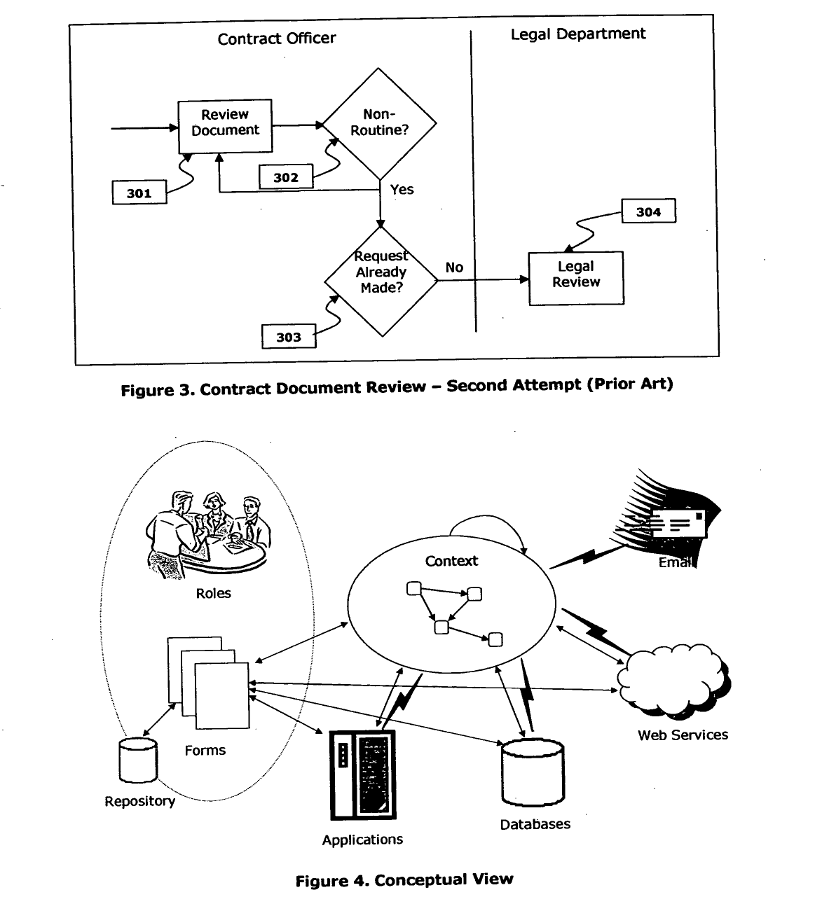

### SUMMARY

Contextual Workflow Modeling (CWM) is centered on a modified finite state machine running strictly in the context of a data environment. The data environment isolates the state machine such that the only way to effect a change in the running status of the state machine is through modifications to the data environment. Instead of focusing on the actions as in the case of AWM, CWM is primarily concerned with how the outcome of an action impacts the data environment.

CWM is a rule-based system where all workflow events, ranging from task initiation to state activation to participant assignments, are governed by user-defined business rules. These rules operate on data drawn from the data environment and form the bridge connecting the data environment to the state machine. On the other hand, the combination of the current workflow status and the participant roles determines who has the privilege and responsibility to modify which part of the data environment. This information is used in conjunction with the current workflow data contents to dynamically generate the current task list for each user. Dynamic generation of the task list ensures that it is always up-to-date without requiring manual intervention.

The CWM approach provides a uniform mechanism through which external actors, whether human users or information systems, interact with the workflow model. There is no artificial distinction of user actions versus system actions in how they impact the data environment, and consequently the workflow status. As a result, integration and interchangeability of the different actor types are much more seamless than in the AWM approach.

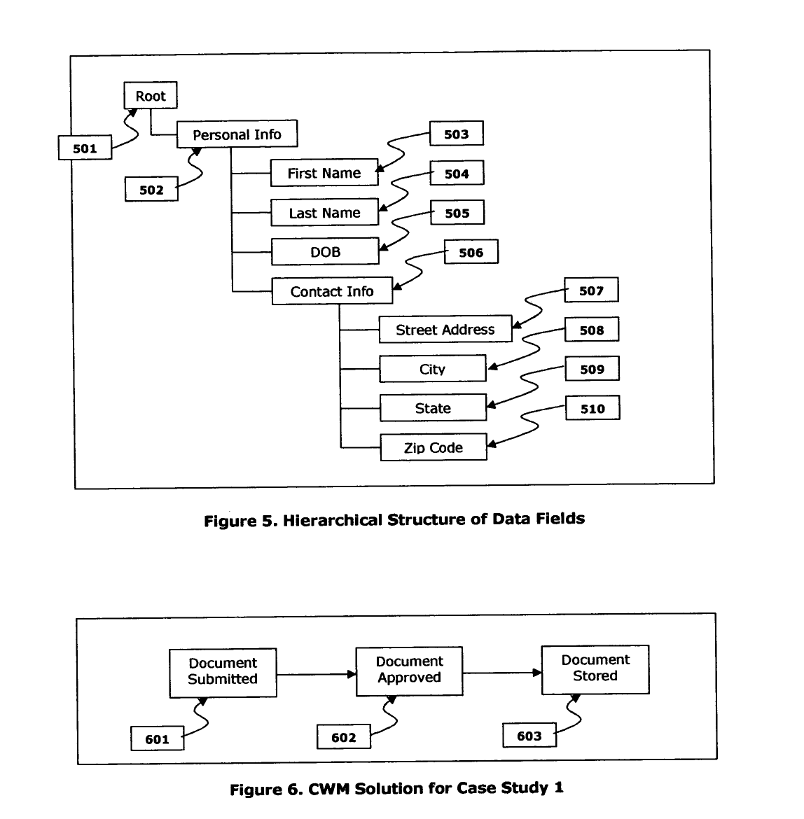

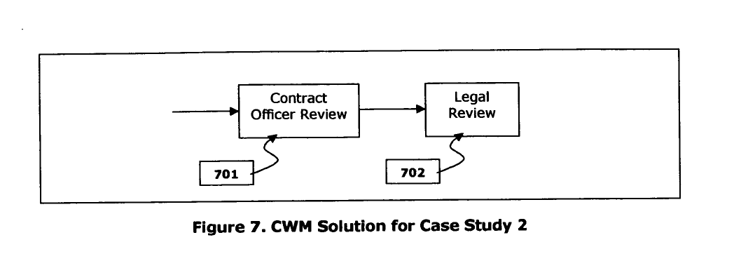

FIGS. 5 and 6 show how the case studies in the Background section can be modeled in CWM. In addition to the ability to capture the exact semantics of these case studies, the CWM workflow diagrams tend to be much more streamlined compared to their AWM counterparts. The reasons for this simplification are two-fold. First, CWM allows business rules and triggers to be tucked away under the respective containers and thus do not clutter up the diagram. Second, CWM provides much greater expressive power than does AWM, allowing fine nuances to be captured within the modeling framework more naturally and with much less effort. The richer semantic structure of CWM enhances comprehension of complex processes by giving analysts a top-level overview of a workflow and allowing them to drill down into particular areas of the workflow as necessary.

CWM represents a radical departure from the typical AWM approach. By switching the modeling focus from actions to states and their driving business rules, and by deriving action requirements dynamically from the workflow data content, CWM puts tremendous expressive power in the hands of the business process architect, allowing him to capture nuances that are simply beyond the reach of AWM.

### DETAILED DESCRIPTION

In one aspect of the invention, the CWM data environment consists of two types of data: system parameters and workflow variables. System parameters are generated automatically as the workflow is executed and include information such as the workflow runtime statistics, the currently active states, the users assigned to each role, etc. System parameters are read-only; they cannot be modified.

Workflow variables are user-defined and can be bound to different data sources including data fields on a form, external databases, scripting functions, external method invocations, or constant values. If a variable is bound to a data field on a form, the variable takes on the data type of the data field. Otherwise, the variable type has to be specified explicitly. Variables can be computed from system parameters as well as from other variables, forming as large an enclosure as necessary to support the workflow business logic. In addition to supporting the business rules, variables also serve as a convenient mechanism for programmatic injection of data into a workflow and for transferring data between different parts of a workflow. Finally, variables can be used in ad-hoc queries supporting the full SQL syntax.

Variables observe scoping rules, enabling them to be defined globally or locally (to a particular form, role, or state). Local variables are often used to prevent pollution of the global namespace and to allow reuse of variable names in different contexts. In case of name conflicts, local variables override global variables with the same names.

Variables can be declared as public, protected, or private. Private variables can only be passed (in read-only mode) into business rules or data binding rules (described later). Protected variables can also be accessed (both read and write) from within business or data binding rules. Public variables are like protected variables but can also be accessed from outside the workflow. In other words, public variables form the public data interface to the workflow.

In another aspect of the invention, users interact with a workflow by filling out forms. The data fields on a form can be bound to variables and hence made available to the data environment. In this invention, forms are dynamic in that the fields on a form can be turned on and off, e.g., made visible and/or editable, conditioned on the current status of the workflow as well as the roles of the participant viewing the form.

The data fields on a form are organized into a hierarchical structure where groups can contain data fields and subgroups. FIG. 5 shows an example of the hierarchical structure of data fields on a form. In the preferred embodiment, a form contains a root group 501 that serves as the parent for all other groups and data fields. The Personal Info group 502 is a subgroup of the root group 501 and contains the data fields First Name 503, Last Name 504, and DOB 505. It also contains the Contact Info subgroup 506, which in turn contains the data fields Street Address 507, City 508, State 509 and Zip Code 510.

In the preferred embodiment, each data field on a form can be bound to one of several data sources:
An attribute store that stores arbitrary attribute values associated with an object
Queries that execute against a database
Scripting code that is interpreted at runtime
Precompiled functions or methods
Web service invocations

Regardless of the data source and binding mechanism, the binding can be parameterized with system parameters and workflow variables. Additionally, data fields on the same form or different forms can be given the same binding name so that they are bound to the same value in the attribute store. This is a convenient way to share data among forms. Otherwise, a data field does not necessarily have to be given a binding name.

A renderer is used to convert the form's hierarchical structure into a form layout such as one that can be displayed in a web browser. Different types of renderers can be used to render the same form for different display client devices. For example, an HTML renderer creates the form layout as an HTML document while a Java Swing renderer creates the form layout as a panel in a Java GUI application. Also, different renderers of the same type can be used to create different layouts for the same display client device. For example, a vertical HTML renderer can render a form in a layout where each data field is displayed on a separate line, while a flow HTML renderer can render the same form with multiple data fields displayed on the same line until the line runs out of space. In the preferred embodiment, a default renderer is specified for each workflow and can be overridden for each form. Also, a global default renderer is specified for use when the workflow-specific default renderer is not specified.

A group can be flagged as logical to give hint to the renderer to treat the group as a special unit but without the default adornments for regular groups. For example, a renderer may render regular groups with a border but only precedes a logical group with a newline character, without the border. How a logical group is treated differently from a regular group is up to the particular renderer.

In addition to the form itself, each group and each data field on a form can be protected with an Access Control List (ACL) for each state in the state machine. An ACL specifies the level of access a user can have to a data field, such as the ability to view or edit the data field. If there are multiple active states, the ACLs for these states are combined and the resulting access privilege is the union of the access privileges from the individual ACLs. This way, the protection of each data field becomes a function of the current running status of the state machine. If a group or data field is not assigned an ACL, it takes on the ACL of the container group in a recursive fashion. Using FIG. 5 as an example, if the Street Address field 507 does not have an ACL then it takes on the ACL of the Contact Info group 506. If the Contact Info group 506 itself does not have an ACL then the data field 507 takes on the ACL of the Personal Info group 502, and so on up the hierarchy. On the other hand, if a data field has an ACL, the data field's ACL can either be combined with or override the ACL from the container group. In the preferred embodiment, the data field's ACL is used to further restrict access privilege as defined by the container group's ACL. In the event that no ACL is available for a data field, it can be interpreted either as no access or full access. In the preferred embodiment, the latter interpretation is selected.

Each data field or group can have an ACL defined for each state. In addition, a default ACL can be defined for each data field or group. If an ACL is not specified for a particular state, the default ACL is used for that state.

Each data field on a form can be optionally declared as a required field. CWM checks for the presence of required, writable fields to determine if a user is required to provide data to the workflow. If all required, writable fields have been filled out then no further action is required from the user. Each form can be in one of three states. A read-only form does not contain a data field that is currently editable by the user. A completed form contains at least one data field, but no required field. that can be edited by the user. Finally, a required form contains at least one required data field that is editable by the user.

A user's to-do list is the list of required forms for that user. The content of this list is generated dynamically from the workflow data. If another user or information system supplies the requisite data then the to-do item will disappear from the list automatically. There is never any left-over action that has to be removed with custom code.

In another aspect of the invention, business rules are implemented as micro-rules, i.e., small pieces of code that evaluate to either true or false. If a rule evaluates to true, it is said to execute successfully and some action is carried out as a result. For example, if a transition rule executes successfully then the associated state transitions are activated. Similarly, if an assignment rule for a participant role executes successfully then users are drawn from the associated resource pools and assigned to the role.

Business rules can be implemented in different ways. In the preferred embodiment, business rules can be implemented as:
A piece of scripting code that is evaluated at runtime
A precompiled function or method
A query that executes against a database
A message such as one that can be sent to a message queue
An XML-based message
A web service invocation

Regardless of how a business rule is implemented, it can be parameterized with system parameters and workflow variables.

Rules drive all aspects of workflow execution. In the preferred embodiment, the following rule types are supported:
Abort Rules—determine when a state is aborted, i.e., removed from the list of active states without setting the completion flag
Activation Rules—govern state activation
Assignment Rules—govern the assignment of users to participant roles
Completion Rules—determine when a state becomes completed
Escalation Rules—define escalation actions associated with time-sensitive states, e.g., sending email reminders or overdue notifications
Execution Rules—determine if a workflow can be executed, e.g., preventing duplicate workflow instances
Transition Rules—govern the transition from one state to the next

In other embodiments, additional rule types may be supported depending on the number of lifecycle stages and other types of business logic that need to be supported. Business rules of the same type can be chained together and executed one at a time, in order, until the first successful rule execution is encountered. Alternatively, any business rule in the chain can be flagged as fall-through so that rule execution will continue past this particular business rule regardless of the outcome of its execution.

Transition rules, escalation rules, and assignment rules are special cases. Each transition rule is associated with one or more states that become instantiated, if not already so, upon successful execution of the transition rule. Each escalation rule is associated with an escalation action that is performed upon the successful execution of the rule. Examples of escalation actions are sending a reminder to the users responsible for meeting a deadline, sending an overdue notification to the workflow administrator, or releasing a particular user from the workflow instance. Each assignment rule is associated with one or more resource pools containing users and other resources that can be assigned to a workflow instance. Upon successful rule execution, resources are drawn from the pools, in order, until the assignment requirements are satisfied.

In another aspect of the invention, triggers are implemented as method invocations that occur as a result of some workflow event. For example, a trigger can be attached to the activation of a particular state so that an external method invocation occurs whenever the state is activated. At times, one may be interested in not only that a state has been activated but also how it was activated. In this scenario, triggers would be attached to the individual activation rules and invoked when the rules execute successfully. As with rules, triggers can be parameterized with system parameters and user-defined variables. The preferred embodiment supports the following types of triggers:
A piece of scripting code that is interpreted at runtime
A precompiled function or method
A query against a database
An email message
A message such as one that can be sent to a message queue
An XML-based message
A web service invocation

In another aspect of the invention, each participant in a workflow takes on one or more roles that, together with the current workflow status, determine the participant's responsibilities for providing data to the workflow as well as his ability to modify select portions of the data environment. A participant can have multiple roles in the same workflow instances. In this case, the participant's responsibilities and privileges are cumulative from all his roles.

Assignments of participants to a workflow instance can be made manually. Alternatively, users can be automatically drawn from resource pools as defined in assignment rules. By default, assignments are made automatically when the workflow instance is created. This default behavior can be overridden by specifying the points in the workflow where assignments to a particular role are to commence. This capability allows just-in-time resource allocation, enabling a more accurate view of enterprise resource utilization in real-time.

Each role has assignment requirements that specify how many participants are allowed to take on this role in a workflow instance. These assignment requirements are expressed as a range of values where the upper limit specifies the desired number of participants in the role while the lower limit specifies the required number of participants in the role. The upper and lower limits can be specified as fixed values or bound to dynamically computed values using the same binding mechanisms used to bind variables and form data fields. In the preferred embodiment, the assignment algorithm strives to meet the upper limit but will settle for the lower limit. Each role can be flagged to allow incremental assignments, drawing resources from the resource pools as soon as available, as opposed to the default all-or-nothing assignment algorithm. Additionally, a role can be flagged so that the user who initiated the workflow instance will become automatically assigned to the workflow instance in that role. Finally, a role can be flagged to disallow the assignment of the workflow instance initiator to that role (for example, to prevent conflict of interests). If the assignment rules for a role cannot assign enough participants to meet the lower limit then the role is said to be stalled. A workflow instance with at least one stalled role is said to be stalled. The role becomes unstalled automatically when the lower limit is satisfied.

In another aspect of the invention, each state in the state machine follows a well-defined lifecycle; the state's progression through its lifecycle is governed by business rules. When a state is instantiated, such as when a transition occurs, it becomes immediately activated by default. However, activation rules can be written to override this default behavior and activate the state only when certain conditions hold true. An active state becomes aborted when at least one of the abortion rules executes successfully. By default, a state becomes completed as soon as there is a transition out of the state. Again, this default behavior can be overridden by specifying completion rules that allow the state to become completed only when certain conditions hold true.

Transitions out of a state can occur only while the state is active. Conversely, as long as a state remains active, outward transitions can occur at anytime. As a result, multiple transitions can occur out of a state throughout its active life. Note that unlike AWM, the occurrence of a transition out of an active state does not necessarily lead to the completion of that state, and vice versa. If a state has no transition or abort rule then it is considered an end state. When all active states in a workflow instance are end states, the workflow instance is considered to be completed.

Each state can optionally have a due date assigned to it. The optional due date can be specified as a duration computed from the state activation time or as a date value. In either case, the duration or date value can be a fixed value or computed using the same binding mechanisms as those used to bind variables and form data fields. The due date can be fixed, sliding, or dynamic. A fixed due date is computed upon state activation and never changes. A sliding due date is recomputed every time the state is re-entered, i.e., instantiated by a transition rule while the state is already active. A dynamic due date is recomputed every time it is accessed or every time the workflow instance is updated. The state due date is used in escalation rules as discussed above.

1. A workflow modeling technique based on a finite state machine executing in a data environment wherein
a) Modifications to the data environment can lead to a change in the running status of the state machine.
b) Each state in the finite state machine follows a well-defined lifecycle including but not limited to the following lifecycle stages: Instantiated, Activated, Aborted, and Completed.
c) Business rules operating on data drawn from the data environment govern the progression of each state through its lifecycle and the transitions from one state to one or more subsequent states.
d) Business rules operating on data drawn from the data environment govern the ability to start a workflow instance.
e) A business rule executes and returns a value that indicates the success or failure of rule execution.

2. The workflow modeling technique in claim 1, wherein each state can take on a single lifecycle stage at any one time.

3. The workflow modeling technique in claim 1, wherein the transitions out of a state are allowed only during specific stages in a state's lifecycle.

4. The workflow modeling technique in claim 3, wherein the transitions out of a state can occur at any time, as long as the state is currently in a lifecycle stage permitting outward transitions.

5. The workflow modeling technique in claim 4, wherein the transitions out of a state are allowed only when the state is in Activated lifecycle state.

6. The workflow modeling technique in claim 1, wherein a state without an outward transition is considered an end state without requiring further special designations.

7. The workflow modeling technique in claim 6, wherein an end state cannot be aborted.

8. The workflow modeling technique in claim 1, wherein a workflow is considered completed when all currently active states are end states.

9. The workflow modeling technique in claim 1, wherein one or more states can be designated as initial states that are automatically instantiated upon creation of a workflow instance.

10. The workflow modeling technique in claim 9, wherein a workflow can be restarted by removing all currently active states and instantiating one or more initial states.

11. The workflow modeling technique in claim 1, wherein the workflow status is updated whenever there is a change in the data environment.

12. The workflow modeling technique in claim 1, wherein the workflow status is updated on a regular basis, according to a predefined schedule.

13. The workflow modeling technique in claim 1, wherein changes in the workflow status including but not limited to state instantiation, state activation, state abortion, state completion and all the corresponding times are captured in an audit log.

14. The workflow modeling technique in claim 1, wherein triggers are associated with any change in the workflow status and invoked when these changes occur.

15. The workflow modeling technique in claim 14, wherein a trigger is a piece of scripting code interpreted at runtime and the scripting code can be parameterized with system parameters and user variables.

16. The workflow modeling technique in claim 14, wherein a trigger is a compiled function or method and the complied function or method can be parameterized with system parameters and user variables.

17. The workflow modeling technique in claim 14, wherein a trigger is an SQL query and the SQL query can be parameterized with system parameters and user variables.

18. The workflow modeling technique in claim 14, wherein a trigger is an email message and the email message can be parameterized with system parameters and user variables.

19. The workflow modeling technique in claim 14, wherein a trigger is a message, such as one that can be sent to a message queue, and the message can be parameterized with system parameters and user variables.

20. The workflow modeling technique in claim 14, wherein a trigger is an XML-based message and the XML-based message can be parameterized with system parameters and user variables.

21. The workflow modeling technique in claim 14, wherein a trigger is a web service invocation and the web service invocation can be parameterized with system parameters and user variables.

22. The workflow modeling technique in claim 1, wherein the data environment consists of system parameters and workflow variables.

23. The workflow modeling technique in claim 22, wherein workflow variables comprise of global variables and local variables.

24. The workflow modeling technique in claim 23, wherein local variables can have the same names as global variables and override the global variables with the same names.

25. The workflow modeling technique in claim 22, wherein system parameters and workflow variables can be scalar-valued or array-valued.

26. The workflow modeling technique in claim 25, wherein automatic conversion is performed between scalar-valued and array-valued variables. Scalar values are converted to arrays with a single entry. Array values are converted to scalar values by selecting a single entry from the array.

27. The workflow modeling technique in claim 26, wherein array values are converted to scalar values by selecting the first entry in the array.

28. The workflow modeling technique in claim 22, wherein automatic type conversion is performed on workflow variables.

29. The workflow modeling technique in claim 22, wherein one or more variables can be designated as primary variables.

30. The workflow modeling technique in claim 29, wherein primary variables are used to differentiate different instances of the same workflow.

31. The workflow modeling technique in claim 30, wherein the ordering of primary variables are used in the differentiation of different instances of the same workflow.

32. The workflow modeling technique in claim 22, wherein a workflow variable can be bound to a data field on a form.

33. The workflow modeling technique in claim 22, wherein a workflow variable can be bound to scripting code that is interpreted at runtime and the scripting code can be parameterized with system parameters and other workflow variables.

34. The workflow modeling technique in claim 22, wherein a workflow variable can be bound to compiled functions or methods and the compiled functions or methods can be parameterized with system parameters and other workflow variables.

35. The workflow modeling technique in claim 22, wherein a workflow variable can be bound to SQL queries and the SQL queries can be parameterized with system parameters and other workflow variables.

36. The workflow modeling technique in claim 22, wherein a workflow variable can be bound to a web service invocation and the web service invocation can be parameterized with system parameters and other workflow variables.

37. The workflow modeling technique in claim 22, wherein a workflow variable can be bound to a constant value or an array of constant values.

38. The workflow modeling technique in claim 22, wherein workflow variables are automatically checked for circular dependencies.

39. The workflow modeling technique in claim 22, wherein the values of workflow variables can be set either programmatically or via a user interface.

40. The workflow modeling technique in claim 1, wherein
a) Users interact with the workflow through one or more forms in a form stack.
b) One or more forms in the form stack can be shared among all workflow participants such that all participant work with a single copy of the form.
c) One or more forms in the form stack can be user-specific such that each workflow participant has his own copy of the form.
d) A form comprises of data fields that can be organized in a hierarchical structure with groups containing subgroups and data fields.

41. The workflow modeling technique in claim 40, wherein a user's access to a form is determined by a combination of the user's role and the current status of the workflow.

42. The workflow modeling technique in claim 41, wherein a user's access to a form is specified as a list of ACLs corresponding to the states in the workflow, with the list of currently active states determining the ACLs to use in a cumulative fashion.

43. The workflow modeling technique in claim 42, wherein a default ACL is used in case a state is not associated with an ACL.

44. The workflow modeling technique in claim 43, wherein a user's access to data fields or groups of data fields on a form is determined by a combination of the user's role and the current status of the workflow.

45. The workflow modeling technique in claim 44, wherein a user's access to data fields or groups of data fields on a form is specified as a list of ACLs corresponding to the states in the workflow, with the list of currently active states determining the ACLs to use in a cumulative fashion.

46. The workflow modeling technique in claim 45, wherein a default ACL is used in case a state is not associated with an ACL.

47. The workflow modeling technique in claim 46, wherein user access propagates down the form's hierarchical structure.

48. The workflow modeling technique in claim 47, wherein the propagated user access can be overridden on a subgroup or data field.

49. The workflow modeling technique in claim 46, wherein a form is dynamically rendered for each user based on the user's current access to the data fields on the form.

50. The workflow modeling technique in claim 49, wherein visible data fields on a form are rearranged to take up space that otherwise would be occupied by invisible fields.

51. The workflow modeling technique in claim 46, wherein each data field on a form can be designated as required and the form can be optionally flagged to force users to fill in all required fields before submitting the form.

52. The workflow modeling technique in claim 51, wherein the presence of one or more required, writable, and unfilled data fields on a form indicates that a user is required to take an action to provide data for these fields and that the form is required.

53. The workflow modeling technique in claim 52, where in a task list for each user is dynamically generated by inspecting the form stack to see if at least one form is required.

54. The workflow modeling technique in claim 51, where in a form with no writable data fields is considered a read-only form and users cannot modify any data field on the form.

55. The workflow modeling technique in claim 51, where in a form with at least one writable data field but no required, writable, unfilled data fields is considered a completed form and users can optionally modify the writable data fields.

56. The workflow modeling technique in claim 40, wherein different data fields in the same form or different forms can be given the same binding name so that these data fields always share the same data value.

57. The workflow modeling technique in claim 40, wherein a particular form in the form stack is designated as the workflow initiation form, i.e., the form that is shown when a user initiates a workflow.

58. The workflow modeling technique in claim 57, wherein the form at the top of the form stack is designated as the workflow initiation form.

59. The workflow modeling technique in claim 40, wherein each data field on a form can be bound to scripting code that is interpreted at runtime and the scripting code can be parameterized with system parameters and workflow variables.

60. The workflow modeling technique in claim 40, wherein each data field on a form can be bound to compiled functions or methods and the complied functions or methods can be parameterized with system parameters and workflow variables.

61. The workflow modeling technique in claim 40, wherein each data field on a form can be bound to SQL queries and the SQL queries can be parameterized with system parameters and workflow variables.

62. The workflow modeling technique in claim 40, wherein each data field on a form can be bound to an object attribute store that can store data attributes of different types for a given object.

63. The workflow modeling technique in claim 40, wherein data fields on a form are automatically checked for circular dependencies.

64. The workflow modeling technique in claim 40, wherein the data values entered for each data field are captured in an audit log.

65. The workflow modeling technique in claim 1, wherein users can be assigned automatically or manually to a workflow instance as participants in one or more roles associated with the workflow.

66. The workflow modeling technique in claim 65, wherein the number of participants in each role can be defined as a range of values, with the upper limit being the desired number of participants and the lower limit being the required number of participants.

67. The workflow modeling technique in claim 66, wherein the upper and/or lower limits can be specified as a fixed value.

68. The workflow modeling technique in claim 66, wherein the upper and/or lower limits are bound to scripting code that is interpreted at runtime and the scripting code can be parameterized with system parameters and workflow variables.

69. The workflow modeling technique in claim 66, wherein the upper and/or lower limits are bound to compiled functions or methods and the complied functions or methods can be parameterized with system parameters and workflow variables.

70. The workflow modeling technique in claim 66, wherein the upper and/or lower limits are bound to SQL queries and the SQL queries can be parameterized with system parameters and workflow variables.

71. The workflow modeling technique in claim 65, wherein a role can be flagged so that assignments to the role can be made either incrementally or in an all- or-nothing fashion.

72. The workflow modeling technique in claim 65, wherein each role is associated with one or more assignment rules, each of which in turn is associated with one or more resource pools, i.e., groups of users and other resources that can be assigned to the workflow. If an assignment rule executes successfully, resources are drawn from the associated resource pools and assigned to the workflow in the given role.

73. The workflow modeling technique in claim 72, wherein one or more states can be selected as the points where automatic assignments to a particular role are to commence.

74. The workflow modeling technique in claim 73, wherein if no commencement points are specified for a role, automatic assignments are made upon the initiation of the workflow instance.

75. The workflow modeling technique in claim 72, wherein the assignment rules are executed in a pre-defined order until the assignment requirement for the associated role is fulfilled.

76. The workflow modeling technique in claim 72, wherein each assignment rule can be associated with triggers that are automatically invoked upon successful execution of the assignment rule.

77. The workflow modeling technique in claim 76, wherein a trigger is a piece of scripting code interpreted at runtime and the scripting code can be parameterized with system parameters and workflow variables.

78. The workflow modeling technique in claim 76, wherein a trigger is a compiled function or method and the complied function or method can be parameterized with system parameters and workflow variables.

79. The workflow modeling technique in claim 76, wherein a trigger is an SQL query and the SQL query can be parameterized with system parameters and workflow variables.

80. The workflow modeling technique in claim 76, wherein a trigger is an email message and the email message can be parameterized with system parameters and workflow variables.

81. The workflow modeling technique in claim 76, wherein a trigger is a message, such as one that can be sent to a message queue, and the message can be parameterized with system parameters and user variables.

82. The workflow modeling technique in claim 76, wherein a trigger is an XML-based message and the XML-based message can be parameterized with system parameters and user variables.

83. The workflow modeling technique in claim 76, wherein a trigger is a web service invocation and the web service invocation can be parameterized with system parameters and user variables.

84. The workflow modeling technique in claim 65, wherein one or more roles can be flagged so that they are automatically assigned to the user who initiated the workflow instance.

85. The workflow modeling technique in claim 65, wherein a role can be flagged so that it will not be automatically assigned to the user who initiated the workflow instance.

86. The workflow modeling technique in claim 1, wherein a business rule can be a piece of scripting code interpreted at runtime and the scripting code can be parameterized with system parameters and workflow variables.

87. The workflow modeling technique in claim 1, wherein a business rule can be a compiled function or method and the function or method can be parameterized with system parameters and workflow variables.

88. The workflow modeling technique in claim 1, wherein a business rule can be a message, such as one that can be sent to a message queue, and the message can be parameterized with system parameters and workflow variables.

89. The workflow modeling technique in claim 1, wherein a business rule can be an XML-based message and the XML-based message can be parameterized with system parameters and workflow variables.

90. The workflow modeling technique in claim 1, wherein a business rule can be a web service invocation and the web service invocation can be parameterized with system parameters and workflow variables.

91. The workflow modeling technique in claim 1, wherein business rules can be chained together and executed in a predefined order.

92. The workflow modeling technique in claim 91, wherein the execution of a chain of business rules is terminated upon the first successful execution of a business rule in the chain.

93. The workflow modeling technique in claim 91, wherein a business rule can be flagged as fall-through so that the execution of a chain of business rules will continue despite the successful execution of this business rule.

94. The workflow modeling technique in claim 1, wherein a business rule can be associated with one or more triggers that are automatically invoked upon successful rule execution.

95. The workflow modeling technique in claim 94, wherein a trigger is a piece of scripting code interpreted at runtime and the scripting code can be parameterized with system parameters and workflow variables.

96. The workflow modeling technique in claim 94, wherein a trigger is a compiled function or method and the complied function or method can be parameterized with system parameters and workflow variables.

97. The workflow modeling technique in claim 94, wherein a trigger is an SQL query and the SQL query can be parameterized with system parameters and workflow variables.

98. The workflow modeling technique in claim 94, wherein a trigger is an email message and the email message can be parameterized with system parameters and workflow variables.

99. The workflow modeling technique in claim 94, wherein a trigger is a message, such as one that can be sent to a message queue, and the message can be parameterized with system parameters and workflow variables.

100. The workflow modeling technique in claim 94, wherein a trigger is an XML-based message and the XML-based message can be parameterized with system parameters and workflow variables.

101. The workflow modeling technique in claim 94, wherein a trigger is a web service invocation and the web service invocation can be parameterized with system parameters and workflow variables.

102. The workflow modeling technique in claim 1, wherein triggers can be associated with the entry into and the exit from each lifecycle stage.

103. The workflow modeling technique in claim 102, wherein a trigger is a piece of scripting code interpreted at runtime and the scripting code can be parameterized with system parameters and workflow variables.

104. The workflow modeling technique in claim 102, wherein a trigger is a compiled function or method and the complied function or method can be parameterized with system parameters and workflow variables.

105. The workflow modeling technique in claim 102, wherein a trigger is an SQL query and the SQL query can be parameterized with system parameters and workflow variables.

106. The workflow modeling technique in claim 102, wherein a trigger is an email message and the email message can be parameterized with system parameters and workflow variables.

107. The workflow modeling technique in claim 102, wherein a trigger is a message, such as one that can be sent to a message queue, and the message can be parameterized with system parameters and workflow variables.

108. The workflow modeling technique in claim 102, wherein a trigger is an XML-based message and the XML-based message can be parameterized with system parameters and workflow variables.

109. The workflow modeling technique in claim 102, wherein a trigger is a web service invocation and the web service invocation can be parameterized with system parameters and workflow variables.

110. The workflow modeling technique in claim 1, wherein a state can optionally have a due time.

111. The workflow modeling technique in claim 110, wherein the due time is computed once when the state is instantiated.

112. The workflow modeling technique in claim 110, wherein the due time is computed once when the state is activated.

113. The workflow modeling technique in claim 110, wherein the due time is recomputed once when an already active state is reactivated.

114. The workflow modeling technique in claim 110, wherein the due time is recomputed every time the workflow instance is updated.

115. The workflow modeling technique in claim 110, wherein the due time is recomputed every time it is accessed.

116. The workflow modeling technique in claim 110, wherein a state can be given a duration and the due time is computed as the start time plus the duration.

117. The workflow modeling technique in claim 116, wherein the start time is start of a state's lifecycle state.

118. The workflow modeling technique in claim 116, wherein the start time is time the workflow instance was initiated.

119. The workflow modeling technique in claim 110, wherein the due time is computed by executing a piece of scripting code interpreted at runtime and the scripting code can be parameterized with system parameters and workflow variables.

120. The workflow modeling technique in claim 110, wherein the due time is computed by executing a compiled function or method and the complied function or method can be parameterized with system parameters and workflow variables.

121. The workflow modeling technique in claim 110, wherein the due time is computed by executing an SQL query and the SQL query can be parameterized with system parameters and workflow variables.

122. The workflow modeling technique in claim 110, wherein a state can be associated with escalation rules that are evaluated on a regular basis and upon successful execution, cause some action to be taken.

123. The workflow modeling technique in claim 122, wherein each escalation rule is can be evaluated successfully at most once.

124. The workflow modeling technique in claim 122, wherein the action associated with an escalation rule is a piece of scripting code that is interpreted at runtime and the scripting code can be parameterized with system parameters and workflow variables.

125. The workflow modeling technique in claim 122, wherein the action associated with an escalation rule is a compiled method or function and the compiled method or function can be parameterized with system parameters and workflow variables.

126. The workflow modeling technique in claim 122, wherein the action associated with an escalation rule is a SQL query and the SQL query can be parameterized with system parameters and workflow variables.

127. The workflow modeling technique in claim 122, wherein the action associated with an escalation rule is an email message and the email message can be parameterized with system parameters and workflow variables.

128. The workflow modeling technique in claim 122, wherein the action associated with an escalation rule is a message, such as one that can be sent to a message queue, and the message can be parameterized with system parameters and workflow variables.

129. The workflow modeling technique in claim 122, wherein the action associated with an escalation rule is an XML-based message and the XML-based message can be parameterized with system parameters and workflow variables.

130. The workflow modeling technique in claim 122, wherein the action associated with an escalation rule is a web service invocation and the web service invocation can be parameterized with system parameters and workflow variables.

131. The workflow modeling technique in claim 122, wherein the escalation rule can be specified as a relative time measured from the due time of the corresponding state.

132. The workflow modeling technique in claim 122, wherein the escalation rule is a piece of scripting code that is interpreted at runtime and the scripting code can be parameterized with system parameters and workflow variables.

133. The workflow modeling technique in claim 122, wherein the escalation rule is a compiled function or method and the compiled function or method can be parameterized with system parameters and workflow variables.

134. The workflow modeling technique in claim 122, wherein the escalation rule is a web service invocation and the web service invocation can be parameterized with system parameters and workflow variables.
